(19) United States
(12) Patent Application Publication
(10) Pub. No.: US 2026/0024365 A1
(43) Pub. Date: Jan. 22, 2026

(54) Systems and Methods for Detecting Artificial Intelligence Generated Images

(71) Applicant: Insurance Services Office, Inc., Jersey City, NJ (US)

(72) Inventors: Stuart Crichton, Newcastle upon Tyne (GB); Palak Jain, Draper, UT (US); Samuel Warren, Salt Lake City, UT (US); Sindhu Hegde, Oxford (GB); Venkata Subbarao Veeravarasapu, Munich (DE); Matthew D. Frei, Lehi, UT (US)

(73) Assignee: Insurance Services Office, Inc., Jersey City, NJ (US)

(21) Appl. No.: 19/266,904

(22) Filed: Jul. 11, 2025

Related U.S. Application Data
(60) Provisional application No. 63/672,855, filed on Jul. 18, 2024.

(51) Int. Cl. G06V 20/00; G06V 10/25; G06V 10/26; G06V 10/42; G06V 10/764; G06V 10/774

(52) U.S. Cl. CPC G06V 20/95; G06V 10/25; G06V 10/26; G06V 10/42; G06V 10/764; G06V 10/774

(57) ABSTRACT

Systems and methods for detecting artificial intelligence generated images are provided. The system accepts an input image (e.g., a digital still image, or a frame from a digital video file or image stream) and subdivides the input image into a set of patches using a patch partitioning algorithm. The system then processes each patch and produces a feature embedding for each patch within a high dimension space. The system then utilizes these patches with further processing as input to machine learning models, which allows the system to achieve image, patch-level, and video-frame generated image classification and localization alongside identification of the generative model used to synthesize the image.

### RELATED APPLICATIONS

This application claims priority to U.S. Provisional Application Ser. No. 63/672,855 filed on Jul. 18, 2024, the entire disclosure of which is expressly incorporated herein by reference.

### BACKGROUND

### Technical Field

The present disclosure relates to the field of artificial intelligence. More specifically, the present disclosure relates to systems and methods for detecting artificial intelligence generated images.

### RELATED ART

In the field of artificial intelligence (AI), the ability to detect AI-generated images and videos is of great importance. Within the insurance industry, the ability to detect AI-generated images or video or those altered with generative AI models as part of a claims process could minimize fraud. Insurance fraud is estimated to cost the US insurance industry 300 billion USD per annum, and as generative AI models become more widespread and within reach of average policyholders, the proportion of this total linked to those manipulated with generative models or fully generated images is likely to increase, as is the total amount of fraud. Any real-time or near-real-time ability to detect such false or manipulated images is therefore likely to aid in the minimization of successful fraudulent insurance claims.

The threat of AI-generated imagery and video is constantly evolving with new models and approaches being utilized. These can range from generation of an entire image to “deepfake” editing of real images, where generative models are used to alter one or more sub-regions of an image. Such edits can be small in nature, and as a result, leave very little evidence (especially after standard image processing pipelines used for digital insurance claims processing). These pipelines generally involve compression and resizing operations to minimize file storage and network transmission requirements.

The task of AI-generated image or editing detection is currently a major research topic both in commercial and academic research settings. Prior efforts fall into two different types of approach for AI-generated image detection: detection of semantic (content) errors, and statistical analysis and separation of real imagery versus generated imagery. Most proposed approaches fall into the second category, since the first approach can involve methods which are in a race condition against the generative capabilities of each new generative model as they are released. As these models have improved, a major reduction in the number of semantic errors produced by models has been seen (e.g., poor generation/rendering of human hands in images).

Statistical approaches to separate real and generated images have also been attempted. An initial approach is to utilize generative models and their inherent reconstruction errors to help identify images that have been generated with them. Others utilize this approach in slightly different manners, but specifically to detect images created by the most recent class of generative models, namely, Latent Diffusion Models (LDM). The basis of such an approach is that images that have been created via a generative AI model should exhibit smaller errors when pushed through the encoding section of a generative model in comparison to a real image. However, a drawback to this approach is the need to ensure that enough generative models are used during this stage to maximize the chance of testing the image with the model that was used to create it, resulting in a model that produces an image with a minimal error.

Another drawback is the race condition against model improvements. With LDMs, there is an inherent error introduced during the encoding of images into a latent space. These models, as they improve, train these encoding sections in order to minimize any error, and as such, as they improve, this reconstruction error will slowly diminish and render such approaches less effective. Additionally, such approaches are tuned to work at the global image level to produce as output an image classification and probability, rather than also detecting smaller localized areas of editing with generated imagery.

Other approaches are based more firmly in the separation of real and generated imagery based upon underlying image statistics. One approach is based upon image statistics caused by capture on the most common imaging sensors based upon the Bayer filter mosaic design. In this design, green sensor sites outnumber red and blue on a 2:1:1 (G:R:B) basis and so they exhibit a particular neighborhood pixel relationship between the 3 color channels during a standard in-camera processing pipeline. It leverages this to extract features from each color channel and uses these as input to train a machine learning algorithm for generated image identification. Once more, this approach is based at the global image level and does not offer the ability to localize smaller regions of edits with generative models.

Another model proposes that a difference exists between real and generated imagery when comparing the high and low texture regions of an image. It proposes that current generative models find it more difficult to generate high texture regions in comparison to those of lower texture. The difference in the rendering of these two regions is what this approach utilizes to determine if an image is real or has been generated. It can again be supposed that such a signal could well become weaker as generative models improve over time.

Other methods utilize the frequency domain, rather than the spatial, for analysis and feature generation. In this regard, one approach further expands upon frequency domain characteristics of generative imagery, which has been noted since earlier model types. It uses a sample of magnitudes in the frequency domain to fingerprint and identify real and generated imagery.

Accordingly, what would be desirable, but has not yet been provided, are systems and methods for detecting artificial intelligence generated images which address the foregoing and other needs.

### SUMMARY

The present disclosure relates to systems and methods for detecting artificial intelligence generated images. The system accepts an input image (e.g., a digital still image, or a frame from a digital video file or image stream) and subdivides the input image into a set of patches using a patch partitioning algorithm. The system then processes each patch and produces a feature embedding for each patch within a high dimension space. The system then utilizes these patches with further processing as input to machine learning models, which allows the system to achieve image, patch-level, and video-frame generated image classification and localization alongside identification of the generative model used to synthesize the image.

### BRIEF DESCRIPTION OF THE DRAWINGS

The foregoing features of the invention will be apparent from the following Detailed Description of the Invention, taken in connection with the accompanying drawings, in which:

FIG. 1 is a flowchart showing the overall processing steps carried out by the systems and methods of the present disclosure;

FIG. 2 is a diagram illustrating various components and operation of the systems and methods of the present disclosure; and

FIG. 3 is a diagram illustrating a machine learning algorithm in accordance with the systems and methods of the present disclosure.

### DETAILED DESCRIPTION

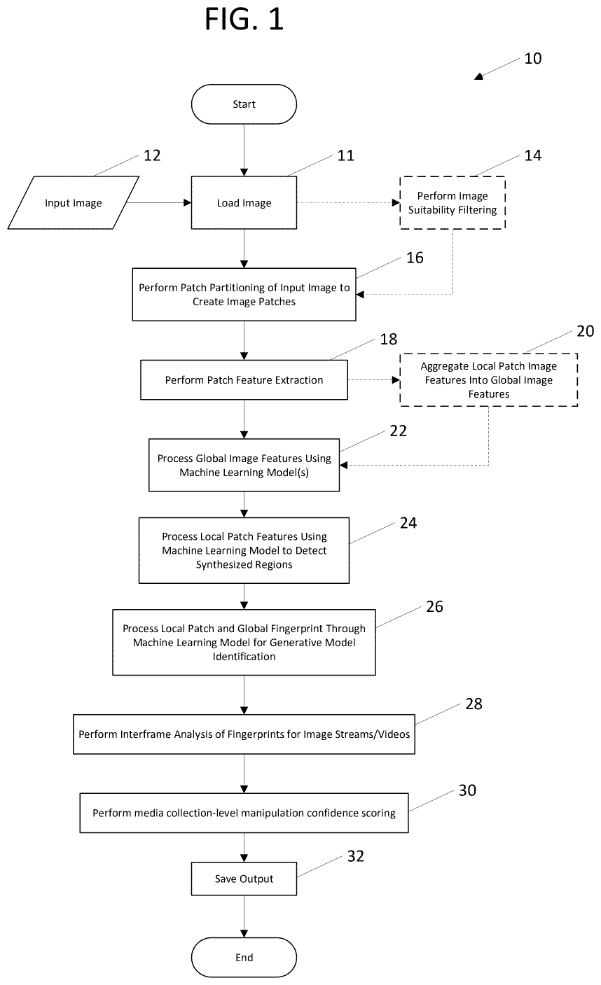

The present disclosure relates to systems and methods for detecting artificial intelligence generated images, as described in detail below in connection with FIGS. 1-3. The systems and methods described herein allow for automatic evaluation of digital media (e.g., images and video) to detect whether an image or video still has been either: (1) entirely generated by an artificial intelligence model (AI generative image/video model); or (2) was originally a real image but has had regions manipulated and edited by such a generative model. As disclosed in detail below, this is achieved by: (a) receiving digital image or video data; (b) analysis of this data using a pipeline of a single or multiple image adulteration and generation detection algorithms; (c) optional identification of regions of the image/video that have been created/edited using a generative model (which may comprise the entire image or smaller sections); (d) if a video file or stream of digital images have been provided, processing these to detect consistency across the different frames and/or a degree to which the video file or stream of digital images appears to have been AI-generated (as well as an indication of which portions are AI-generated); (e) returning a classification on whether the image or video has been created/edited using a generative model; (f) if the image/still is determined to be generated, then optionally returning a classification on the generative model used to create it; and (g) if the image or video has been created/edited using a generative model, producing a localization map which provides a manipulation confidence value per pixel or patch (for localization).

The systems and methods disclosed herein are not limited to solely the insurance field for claim evidence verification, and have applications across multiple fields including validation of press or citizen press imagery and videos (whether in traditional or social media to combat fake news), or for the validation and verification of images and video supplied in a legal setting. Further uses could include validation of images used on online auction or shopping applications and sites.

The systems and methods of the present disclosure work on the native input size of the image, disregarding image resizing to preserve the underlying image statistics. Additionally, the systems and methods disclosed herein can utilize one or more of the technologies disclosed in U.S. Pat. Nos. 11,663,489 and 11,392,800, as well as U.S. Provisional Application Ser. No. 63/530,869 and published U.S. application Ser. No. 18/791,929 (published as U.S. Patent Application Publication No. 2025/0046105 A1). In this regard, digital images generally have specific characteristics inherent to the camera sensor utilized to capture such images. The systems and methods of the present disclosure leverage the knowledge that images captured using imaging devices (CCD/CMOS sensors) have inherent characteristics that allow the system to characterize and link images captured to the device using a fingerprint extracted via algorithmic processes. The systems and methods of the present disclosure differ from the aforementioned patent properties as the inventions disclose therein identify manual manipulation of genuine images, while the systems and methods of the present disclosure repurpose and extend such inventions for the identification of AI-generated or AI-manipulated imagery.

Generative image and video models are trained on very large datasets containing from millions to billions of images whose contents come from a wide number of imaging devices. Images generated by such models tend to not have a fingerprint related to a single image capture device, unlike a real image, but a learned average capture device fingerprint inherited from the dataset upon which they were trained and adapted by the model architecture that has learned it. Images which have been fully generated by such models should have such a generic, but model-linked, fingerprint. Different generative models are also trained on different sets of data, alongside different model architectures. This will also result in a different fingerprint for each generative model, whereas real images which have had smaller regions of edits created by a generative model and inserted should contain a fingerprint inconsistency across these regions. The extracted fingerprint features are supplied to machine learning models to allow the classification of the image or individual patch.

Furthermore, while the above discusses the usage of the systems and methods of the present disclosure for the detection and localization of single images, the systems and methods discussed herein can be further leveraged, such as in connection with analysis of image streams or digital videos, where the systems and methods can be applied to analyze multiple frames and detect fingerprint inconsistency across these frames and/or entirely AI-generated videos to determine if the video is likely to have been created or altered with a generative model.

The systems and methods of the present disclosure leverage the difference in fingerprints between device-captured images and those which have been generated or altered with generative models. This allows the system to detect, localize, and classify images, image streams and videos as having been either generated or edited using a generative AI model or even multiple models. The systems and methods herein are linked to both physical imaging device capture and how generative models are trained with large scale datasets, and are applicable to both global classification and localized detection of edits. Further the systems and methods discussed herein are not limited to the LDM class of generative models.

FIG. 1 is a flowchart, indicated generally at 10, illustrating processing steps carried out by the systems and methods of the present disclosure. In step 11, the system loads an input image 12 from an appropriate image source. The input image 12 can include a single image, an image stream, a video file, or other format. Further, the image 12 can be a single digital image or a single frame from a video or multi-frame image. In optional step 14, the system performs image suitability filtering, which filters out images that are inadequate for processing by the systems and methods disclosed herein. Such filtering may include removal of images that are too small in resolution terms, of too low a quality, compressed too heavily, or which have specific contents.

In step 16, the system performs patch partitioning of the input image 12 to create image patches (which are portions of the original input image). These patches cover the entire image and can do so in either an overlapping or non-overlapping manner. Then, in step 18, the system processes each patch to calculate a feature embedding for each patch in a high-dimensional feature space. This step could be carried out using a suitable patch feature embedding technique, such as that disclosed in the aforementioned U.S. Provisional Application Ser. No. 63/530,869 and published U.S. application Ser. No. 18/791,929 (published as U.S. Patent Application Publication No. 2025/0046105 A1).

In optional step 20, the system processes the features from each patch to generate an overall (global) image level embedding. This can be achieved using different methods of manual patch feature aggregation across the image, including, but not limited to, averaging, standard deviation, summation, concatenation, minimum, and maximum. Next, in step 22, the overall image level embedding or unaggregated vector of patch embeddings is used as the input to a machine learning algorithm which processes the embeddings to infer an image or frame level output decision for the image. The output here includes a confidence relating to an image level decision if the image has been created by a generative AI model or edited by one. This is achieved using a machine learning algorithm with a binary classification head, enabling a binary decision output of “real” or “generated” to be output along with an associated confidence value.

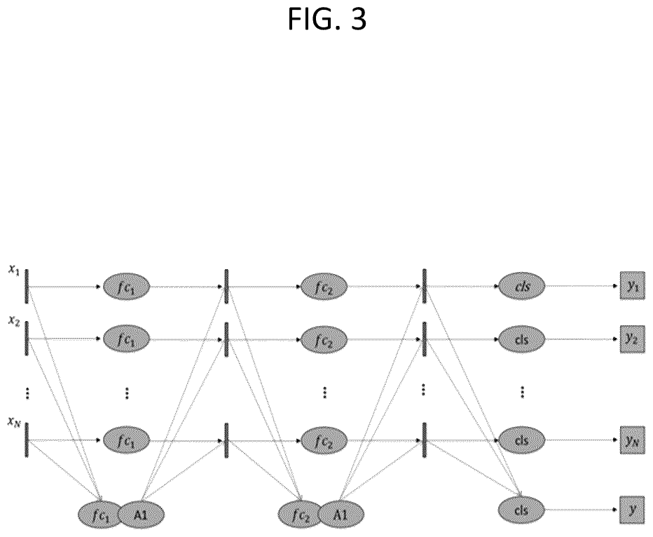

In step 24, the system processes local patch features using a machine learning model to detect synthesized regions. In this step, the patch embeddings are processed with a machine learning module to localize areas of the image that have been generated using a generative AI model. This can be achieved using, for example, an individual classifier such as that discussed above in connection with step 22, and/or the techniques described in the aforementioned U.S. Provisional Application Ser. No. 63/530,869 and published U.S. application Ser. No. 18/791,929 (published as U.S. Patent Application Publication No. 2025/0046105 A1). Next, in step 26, the system classifies the type of generative model used to generate the localized edit using the same fingerprint input (global or local patch). This can output a different classification for each patch, and can be generated using the model described herein in connection with FIG. 3. In step 28, the system performs interframe analysis of fingerprints for the image streams/videos. This can occur if the input file contains a number of still frames from a video file or image burst, and involves processing both the patch features and aggregated image level features, if computed, for each frame in the image. The system utilizes methods to determine if there is fingerprint consistency across the supplied frames using the extracted fingerprint, and/or a degree to which the video file or stream of digital images appears to have been AI-generated (as well as an indication of which portions are AI-generated), regardless of consistency. These methods range from a machine learning model to more rigid statistical rules.

In step 30, the system performs an overall collection/claims level confidence scoring calculated from the model outputs from all media supplied together to the system, where this data could be considered all being from the same insurance claim. Additionally, the claims-level score can be based on more than just the media of the claim, and can be based on other predictors such as the number of previously-investigated claims, the time since policy inception, and other predictors. Further, the score can combine traditional insurance fraud scoring features with new features derived from digital media forensics. Lastly, in step 32, the system generates and saves output which includes, but is not limited to: (1) an overall image level decision (e.g., confidence value) on whether the image has, either in totality or partially, been generated with a generative AI model; (2) a classification of the generative model used to produce the image or each patch; (3) a graphical representation (localization or segmentation) of the locations in the image that have been generated; (4) an overall inter-frame decision on whether any video frames/single frames from a stream have, either in totality or partially, been generated with a generative AI model; and (5) an overall score indicating the confidence that at least one asset from a collection of media (such as all those used for processing a single insurance claim) has, in totality or partially, been generated by AI.

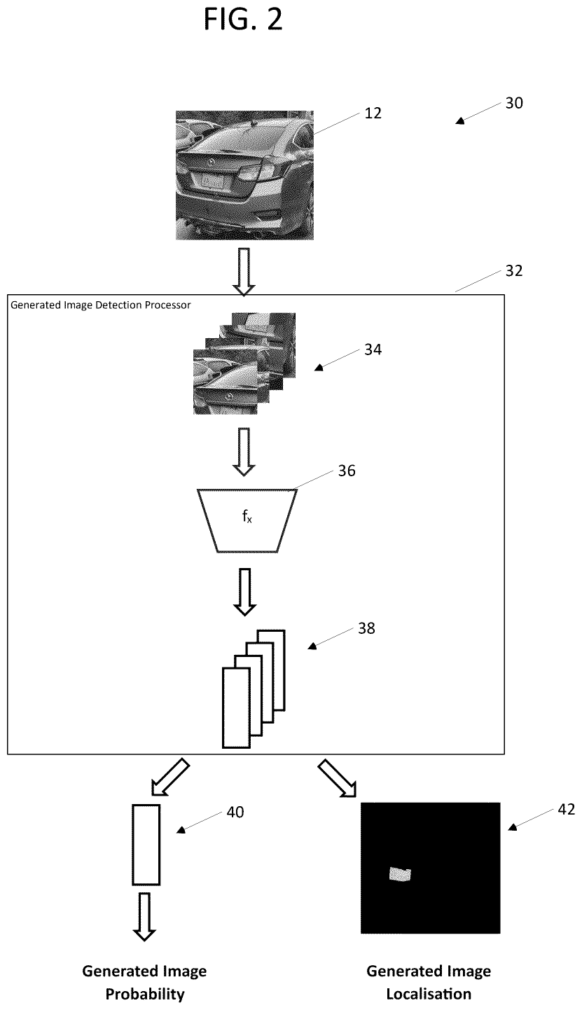

FIG. 2 is a diagram illustrating components and operation of the system of the present disclosure, indicated generally at 30. The process steps discussed above in connection with FIG. 1 could be stored on and/or executed by a generated image detection processor 32 (which could include, but is not limited to, a computer system, mobile phone, server, cloud processing platform, an application-specific integrated circuit (ASIC), a field-programmable gate array (FPGA), a graphics processing unit (GPU), a central processing unit (CPU), microprocessor, or other suitable type of computing device. The processing steps of FIG. 1 could be programmed in an suitable, high-level or low-level computer programming language (including, but not limited to, C, C++, C#, Java, Python, or any other suitable language) and could embodied as computer-readable instructions stored on a suitable non-transitory, computer-readable storage medium (including, but not limited to, disk, flash memory, electrically-programmable, eraseable, read-only memory (EEPROM), or any other suitable storage medium) in communication with the processor 32. The processor 32 processes the input image 12 and generates as output a generated image probability 40 and a localization 42 which illustrates which areas of the input image have been generated by AI.

Using the steps discussed above in connection with FIG. 1, the processor 32 partitions the input image 12 into a set of patches 34 of k×z in size. Each of these patches 34 is then processed by model 36 to generate patch-level embeddings 38. These patch level embeddings 38 are then treated in 2 different ways: (1) they are fed (potentially in aggregated form) into a machine learning algorithm to produce a generated image confidence for the entire image (which could be expressed as the image probability 40); and (2) the embeddings for each patch are utilized to localise smaller regions of generated model edits (as indicated in the localization 42). A loss function could also be included, which encourages the model to make more consistent decisions at the global and local levels. This alleviates and/or prevents the model from struggling to identify areas of image that are AI-generated or AI-modified. Specifically, the model can be penalized if the detector and the localizer predictions differ in their decisions. A simple binary classifier can be added which considers the decisions (potentially based on global and local rules like thresholding) of the detector and localizer and predicts if their decisions are consistent or not. Another way to achieve this is to train an ensemble model which can consider these decisions and provide a final manipulated/non-manipulated output. This alleviates and/or prevents the model from struggling to identify areas of image that are AI-generated or AI-modified.

FIG. 3 illustrates one example embodiment of a machine learning model in accordance with the present disclosure for classification of AI generated images. In practice, many classification methods/architectures can be used. For example, neural networks, tree-based models, transformer-based methods, support vector machines, and more. The first layer, referred to as the input layer fc1, is fully connected, meaning that each node in this layer is connected to every node in the subsequent layer. Following the input layer fel is an activation function A1. Subsequently, the transformed features pass through another fully connected layer fc2 and activation function A1. Finally, the output layer cls is another activation function that generates predicted probabilities for each class in the classification task, whether at the image or patch level.

During the training phase, the network of FIG. 3 adjusts the weights associated with each connection between neurons using backpropagation and gradient descent techniques. The network (model) is trained on images from several sources, including real images coming from an in-house and publicly available sets of image and video data. Generated data comes from multiple commercial and non-commercial services covering a large number of different generative models such that the systems/methods disclosed herein have knowledge of as many possible generated image sources as possible. This data is then augmented in multiple ways to replicate image quality and statistics expected of images being uploaded and captured by people.

Data augmentation functions can be utilized to increase the performance and reliability of the solution. For example, it is well known that aggressive JPEG compression can obscure the camera feature fingerprints which the models of the present disclosure utilize. To mitigate this effect, the system can compress the training images at various levels to provide the models with the ability to recognize and extract camera signatures in a compressed setting.

All machine-learning based solutions are inherently limited in the variety of data which they can process. The systems and methods disclosed herein include suitability filters designed to avoid the potential over-identification of AI-generated or AI-manipulated media. These filters assess input images to determine suitability for processing by the system, and include estimation of the compression level of an image, the presence of a camera model fingerprint, the size of the image, the image texture and exposure levels, and similar features known to correlate with model performance. Thresholds are selected for one more such filters with images above or below the noted thresholds excluded from further processing.

The systems and methods disclosed herein may optionally include a model monitoring component which evaluates the images/video and other data presented to the system for analysis, and alerts the system's administrators when a sufficient change to the inputs has occurred that model retraining should be performed. Examples of model input changes include but are not limited to the introduction of new image/video generation algorithms or algorithm versions, the introduction of new camera models, images/video taken of different scene types, images/video captured in new file formats, using new encryption methods or levels, photos/video failing suitability filters at higher rates, etc. The model monitoring system can monitor metadata information such as camera metadata stored in image metadata standards such as exif—provided directly by upstream systems and processes, or extracted from logs of the current system—for example, suitability filter outputs, or other components. In addition, the machine learning models used in this system include the creation of embeddings spaces from which features can be extracted and monitored at multiple levels, e.g., the patch-level features generated in step 18 or global features in step 20, or the feature embeddings used in the global and patch level classifications conducted in step 24.

The distributions of these various features can be monitored both via simple rules and more complex statistical and machine learning processes. For example, simple rules may identify when at least a certain number of images have been received from a previously unused camera model. Simple statistical measure over time can be analyzed using basic descriptive statistics such as mean, median, variance, skewness, and kurtosis with thresholds set to trigger alerts when these metrics change substantially. Further, statistical methods which compare distributions can be used to determine whether data inputs and features are changing over time. Examples of these statistical methods include Kolmogorov-Smirnov tests, the Anderson-Darling test, the Mann-Whitney U test, and the Chi-Square test. Further, machine learning models including anomaly detection techniques can be employed to monitor for changes in these data distributions.

Regardless of how the data drifts are detected, alerts can be generated and routed to the administrators of the system to notify them of a change in data inputs, describe the change, and potentially recommend that retraining the generated image detection models are required. The output of the monitoring system can also be visualized using dashboarding or other data visualization tools.

Having thus described the systems and methods in detail, it is to be understood that the foregoing description is not intended to limit the spirit or scope thereof. It will be understood that the embodiments of the present disclosure described herein are merely exemplary and that a person skilled in the art can make any variations and modification without departing from the spirit and scope of the disclosure. All such variations and modifications, including those discussed above, are intended to be included within the scope of the disclosure.

What is claimed is:

1. A system for detecting artificial intelligence generated images, comprising:
a generated image detection processor receiving an input image, the generated image detection processor programmed to:
partition the input image into a set of patches;
process the set of patches to generate a plurality of patch-level embeddings;
process the patch-level embeddings by a detector to produce a probability value for the input image indicating a probability that the input image is generated by artificial intelligence; and
localize by a localizer at least one area of the input image that is generated by artificial intelligence utilizing the patch-level embeddings.

2. The system of claim 1, wherein the processor is programmed to perform image suitability filtering on the input image.

3. The system of claim 1, wherein the processor generates an overall image-level embedding for the input image.

4. The system of claim 1, wherein the processor aggregates local patch image features into global image features and processes the global image features using a machine learning model to infer an image- or frame-level output decision for the input image.

5. The system of claim 4, wherein the processor processes the local patch image features to detect synthesized regions of the input image.

6. The system of claim 5, wherein the processor classifies a type of generative model used to generate a localized edit in the input image.

7. The system of claim 1, wherein the processor performs interframe analysis of one or more fingerprints for an image stream or a video.

8. The system of claim 7, wherein the processor determines if fingerprint consistency exists across frames of the image stream or video.

9. The system of claim 1, wherein the processor determines whether decisions by the detector and the localizer are consistent.

10. The system of claim 1, wherein the processor compresses training images for training the processor to recognize and extract camera signatures.

11. A method for detecting artificial intelligence generated images, comprising:
receiving an input image;
partitioning the input image into a set of patches;
processing the set of patches to generate a plurality of patch-level embeddings;
processing the patch-level embeddings by a detector to produce a probability value for the input image indicating a probability that the input image is generated by artificial intelligence; and
localizing by a localizer at least one area of the input image that is generated by artificial intelligence utilizing the patch-level embeddings.

12. The method of claim 11, further comprising performing image suitability filtering on the input image.

13. The method of claim 11, further comprising generating an overall image-level embedding for the input image.

14. The method of claim 11, further comprising aggregating local patch image features into global image features and processes the global image features using a machine learning model to infer an image- or frame-level output decision for the input image.

15. The method of claim 14, further comprising processing the local patch image features to detect synthesized regions of the input image.

16. The method of claim 15, further comprising classifying a type of generative model used to generate a localized edit in the input image.

17. The method of claim 11, further comprising performing interframe analysis of one or more fingerprints for an image stream or a video.

18. The method of claim 7, further comprising determining if fingerprint consistency exists across frames of the image stream or video.

19. The method of claim 11, further comprising determining whether decisions by the detector and the localizer are consistent.

20. The method of claim 11, further comprising compressing training images for training the processor to recognize and extract camera signatures.
